(19) United States
(12) Patent Application Publication
(10) Pub. No.: US 2023/0178877 A1
(43) Pub. Date: Jun. 8, 2023

(54) PCBA, Radio Unit and Base Station

(71) Applicant: Telefonaktiebolaget LM Ericsson (publ), Stockholm (SE)

(72) Inventors: Yuchun Deng, Beijing (CN); Qingxue Xu, Beijing (CN); Chenglong Yin, Beijing (CN); Deyu Liu, Beijing (CN)

(21) Appl. No.: 18/071,701

(22) Filed: Nov. 30, 2022

(30) Foreign Application Priority Data
Dec. 2, 2021 (CN) 202123115596.4

(51) Int. Cl. H01Q 1/24; H01Q 1/38; H01Q 1/52

(52) U.S. Cl. CPC H01Q 1/246; H01Q 1/38; H01Q 1/526

(57) ABSTRACT

A printed-circuit board assembly (PCBA), a radio unit, and a base station. The PCBA comprises a printed circuit board and a plurality of electronic devices disposed on the printed circuit board. The PCBA further comprises a dielectric layer and a conductive layer that cover the electronic devices to shield the plurality of electronic devices, wherein the dielectric layer is arranged between the electronic devices and the conductive layer. According to the disclosure, the dielectric layer and conductive layer disposed on one side of the printed circuit board can shield the electronic devices, which makes it unnecessary to provide a shielding cover made of metal, thus decreasing the weight and volume of the PCBA and reducing the cost. Moreover, the PCBA is easy to manufacture, as the dielectric layer and the conductive layer can be bonded to the printed circuit board through a known process such as vacuum thermoforming.

### TECHNICAL FIELD

This disclosure relates to the field of communication equipment, more particularly, to a printed circuit board assembly (PCBA), a radio unit including the PCBA, and a base station including the radio unit.

### BACKGROUND

It is undesirable for an electronic device in operation to be interfered with by external electromagnetic waves or to radiate electromagnetic waves that may interfere with external devices and endanger human health. Therefore, there is a need to block the propagation path of electromagnetic waves. This is usually called electromagnetic (EM) shielding or radio frequency (RF) shielding. With the development of communication technology, especially 5G, a large number of antennas, chips and other components need to be integrated together to form a miniaturized and highly integrated base station. This places higher requirements for EM shielding and heat dissipation of base station products.

FIG. 1 shows a radio product architecture used in a communication device, wherein a PCBA 10 is mounted with its first side on a frame 11, and a shielding cover 12 is mounted on a second side of the PCBA 10. The PCBA 10 comprises a printed circuit board which is usually designed as a rigid multilayer board, on both sides of which electronic devices are mounted. The RF interference of all electronic devices is prevented by means of the frame 11 and the shielding cover 12 made of metal.

In the radio product architecture shown in FIG. 1, the frame 11 mainly plays the role of supporting the PCBA 10, and it is further provided with a heat sink to enhance the heat dissipation effect. On the other hand, as a metal piece made by a die casting process, the shielding cover 12 is only used to shield the electronic devices in the PCBA 10 to prevent unwanted RF radiation. If the shielding cover 12 can be dispensed with, beneficial effects can be produced in terms of product miniaturization and cost reduction.

### SUMMARY

The disclosure is proposed in view of the above background, and aims to provide a shielding solution that is conducive to product miniaturization and lightweight and cost reduction.

Specifically, a first aspect of the disclosure relates to a PCBA comprising a printed circuit board and a plurality of electronic devices disposed on the printed circuit board. The PCBA further comprises a dielectric layer and a conductive layer that covers the plurality of electronic devices to shield the plurality of electronic devices, where the dielectric layer is arranged between the plurality of electronic devices and the conductive layer.

In an embodiment of the disclosure, the printed circuit board is a multilayer board comprising a ground layer that surrounds the plurality of electronic devices to define a shielding area, and the conductive layer is connected to the ground layer.

In an embodiment of the disclosure, the printed circuit board is a rigid board or a rigid portion of a rigid-flex board.

In an embodiment of the disclosure, the plurality of electronic devices include at least one of a capacitor, a resistor, an inductor, a chip, and a filter.

In an embodiment of the disclosure, the plurality of electronic devices have different protrusion heights on the printed circuit board.

In an embodiment of the disclosure, the dielectric layer is a film made of a non-conductive elastomer material.

In an embodiment of the disclosure, the conductive layer is a film made of a conductive elastomer material.

In an embodiment of the disclosure, the dielectric layer and the conductive layer are bonded to the printed circuit board by vacuum thermoforming, spray coating of film adhesion.

A second aspect of the disclosure relates to a radio unit comprising the PCBA as described above.

A third aspect of the disclosure relates to a base station comprising the radio unit as described above.

According to the disclosure, the dielectric layer and conductive layer disposed on one side of the printed circuit board can shield the electronic devices, which makes it unnecessary to provide a shielding cover made of metal, thus decreasing the weight and volume of the PCBA and reducing the cost. Moreover, the PCBA is easy to manufacture, as the dielectric layer and the conductive layer can be bonded to the printed circuit board through a known process such as vacuum thermoforming.

### BRIEF DESCRIPTION OF THE DRAWINGS

The aforementioned and other aspects, features and advantages in various embodiments of the disclosure become more apparent from the following detailed description with reference to the drawings. In the drawings, identical reference signs or numerals represent identical or similar elements. The drawings are not necessarily drawn to scale, in which

FIG. 1 is a sectional diagram showing an existing radio product architecture;

FIG. 2 is a sectional diagram showing a PCBA according to an embodiment of the disclosure;

FIG. 3 is a top view of the PCBA in FIG. 2;

FIG. 4 is a schematic diagram showing a PCBA manufacturing method according to an embodiment of the disclosure.

### DETAILED DESCRIPTION

Exemplary embodiments of the presently dislcosed invention will be described below in combination with the accompanying drawings. It should be noted that the described embodiments are only examples o and are not intended to limit the utility model. All other embodiments that can be obtained by those skilled in the art based on the described embodiments without creative effort fall within the scope of the invention.

FIG. 2 is a sectional view schematically showing a PCBA according to an embodiment of the disclosure, and FIG. 3 is a top view of the PCBA. The PCBA according to this embodiment is applicable to various occasions, such as a base station, and more specifically, a radio unit of a base station. As an example, the radio unit can be a Remote Radio Unit (RRU) in a 4G base station, or an Active Antenna System (AAS) that integrates an RF module and an antenna module in a 5G base station. The radio unit of the base station may contain a large number of PCBAs.

As shown in FIG. 2, the PCBA comprises a printed circuit board 1 and a plurality of electronic devices 2 disposed on the printed circuit board 1. The printed circuit board 1 in this embodiment is a hard or rigid multilayer board, such as a six-layer board. FIG. 2 only schematically shows the electronic device 2 located on the upper side or the top side of the printed circuit board 1. However, it will be appreciated by those skilled in the art that both sides of the printed circuit board 1 can be provided with a signal layer including a plurality of electronic devices. The printed circuit board 1 is further provided with at least one ground layer 3 and a power supply layer between the top signal layer and the bottom signal layer not shown, and can also be provided with one or more intermediate signal layers. There is no special limit on the number of electronic devices 2 in each signal layer, and FIG. 2 only shows five electronic devices 2 in the top signal layer. Depending on the specific application of the PCBA, these electronic devices 2 may include capacitors, resistors, inductors, chips, filters, etc. The electronic devices 2 can be soldered on the printed circuit board 1, for example, by surface mount technology (SMT). The projection heights of the plurality of electronic devices 2 on the printed circuit board 1 may be different from each other.

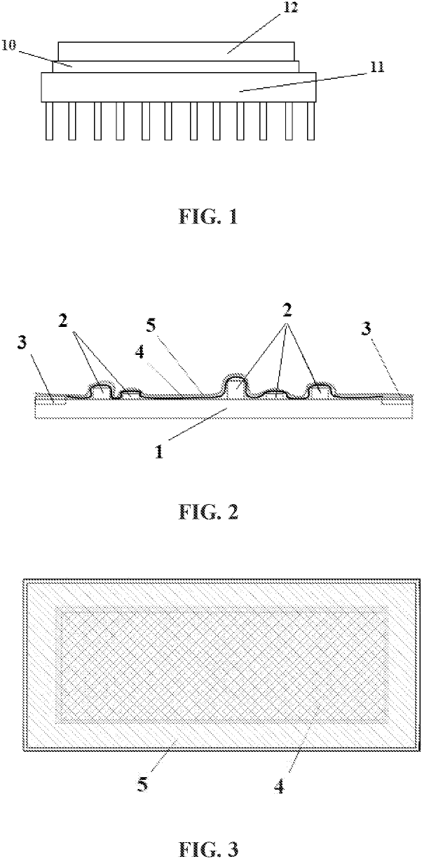

The PCBA can be mounted on a frame (not shown) at the lower side of FIG. 2. The frame is similar to the frame 11 shown in FIG. 1, may be made of a material with good thermal conductivity, such as aluminium, and can also be provided with a heat sink to enhance the heat dissipation effect. The frame is further provided with a structure for shielding the PCBA, especially the electronic devices on the bottom signal layer thereof. Such a shielding structure is well known to those skilled in the art, and detailed description thereof is omitted.

In place of the shielding cover 12 shown in FIG. 1, a dielectric layer 4 and a conductive layer 5 are arranged on the PCBA of the embodiment to shield the electronic devices 2 on the top signal layer. This will be described in detail below.

The dielectric layer 4 is a film made of a non-conductive elastomer material, such as a polyimide film (PI film), a polyester film (PET film), etc. The conductive layer 5 is a film made of a conductive elastomer material, such as a polymer conductive film, an indium tin oxide (ITO) film, etc. The dielectric layer 4 is arranged between the electronic devices 2 and the conductive layer 5 and covers the electronic devices 2 to prevent the electronic devices 2 from electrically connecting with the conductive layer 5 and causing a short circuit. The conductive layer 5 covers the dielectric layer 4 and is connected to the ground layer 3 of the printed circuit board 1. It will be appreciated by those skilled in the art that the ground layer 3 forms a closed loop around a plurality of electronic devices 2 to define one or more shielding areas on the printed circuit board 1. The dielectric layer 4 does not cover the ground layer 3, allowing it to be exposed for electrical connection with the conductive layer 5. As shown in the top view of FIG. 3, the area of the conductive layer 5 is larger than the area of the dielectric layer 4, and the peripheral part of the conductive layer 5 can be connected to the ground layer 3, thereby shielding the corresponding multiple electronic devices 2.

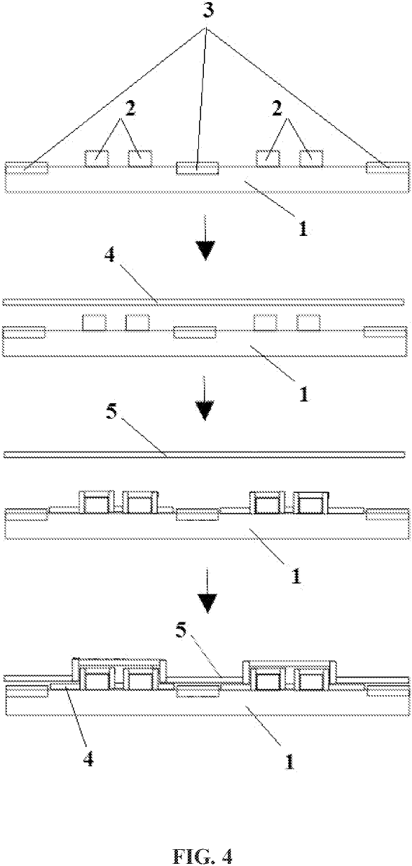

The dielectric layer 4 and the conductive layer 5 can be bonded to the printed circuit board 1 by a known process such as vacuum thermoforming, spray coating or film adhesion. FIG. 4 schematically shows the main steps of the method for manufacturing a PCBA through a vacuum thermoforming process according to an embodiment of the disclosure.

First, a printed circuit board 1 is made by taking polytetrafluoroethylene resin (PTFE), for example, as a base material, and a ground layer 3 is formed and electronic devices 2 are mounted on the printed circuit board. This process is well known to those skilled in the art, and detailed description thereof is omitted.

Then, a polyimide film (PI film) or a polyester film (PET film) for forming a dielectric layer 4 is hot pressed on one side of the printed circuit board 1, covering all the electronic devices 2 on the side. The thickness of the dielectric layer film may be 30~50 um. In one example, the specific process and control parameters are as follows: the heating temperature is set to about 140° C., and when the mold temperature reaches about 125° C., the softened film is pressed on a preset area of the printed circuit board 1 with the punch; a certain air pressure is applied between the film and the printed circuit board 1 for 2-3 minutes; stopping heating and letting cooling water flow through the mold to reduce the mold temperature to about 60° C.; releasing the air pressure and vacuuming, so that the film is attached to the printed circuit board 1 to form the dielectric layer 4 that covers the electronic devices 2; lifting the punch and removing the mold. In the case where the dielectric layer film covers the ground layer 3 on the printed circuit board 1, especially the ground layer 3 in the central portion, part of the dielectric layer film is removed by cutting or other means to expose the ground layer 3.

After forming the dielectric layer 4 as described above, a polymer conductive film or an indium tin oxide (ITO) film for forming a conductive layer 5 is hot pressed on the printed circuit board 1, covering the dielectric layer 4 and the exposed ground layer 3. The thickness of the conductive layer film may be 30~50 um. In one example, the specific process and control parameters are as follows: the heating temperature is set to about 190° C., and when the mold temperature reaches about 130° C., the softened film is pressed on the entire printed circuit board 1 with the punch; a certain air pressure is applied between the film and the printed circuit board 1 when the temperature reaches about 150° C., and the mold stays for 2-3 minutes after the mold temperature reaches 190° C.; stopping heating to reduce the mold temperature; releasing the air pressure and vacuuming, so that the film is attached to the printed circuit board 1 to form the conductive layer 5 that covers the entire printed circuit board 1; lifting the punch and removing the mold. In the case where the conductive layer film exceeds the edge of the printed circuit board 1, the excess conductive layer film is removed by cutting or other means.

Thus, a PCBA according to emobdiments of the invention is formed. In the example shown in FIG. 4, the ground layer 3 divides the upper side of the printed circuit board 1 into two closed shielding areas, for each of which two electronic devices 2 are shown in the figure. On the other side away from the dielectric layer 4 and the conductive layer 5, the PCBA in this example can be mounted in a conventional way on the frame 11 having a heat sink as shown in FIG. 1, and detailed description thereof is omitted.

In contrast to the existing radio product architecture shown in FIG. 1, in the PCBA according to the above embodiments, the dielectric layer 4 and conductive layer 5 are arranged on one side of the printed circuit board to shield the electronic devices 2, which makes it unnecessary to provide a shielding cover 12 made of metal. Therefore, the weight and volume of the PCBA and the radio unit comprising the same is decreased, and the cost is reduced. In some applications, depending on the size of the radio product, the total volume of the product may be reduced by more than 0.5 L, and the total weight may be reduced by more than 1.5 kg, which will greatly improve the competitiveness of the product in the market.

Moreover, as films made of conductive or non-conductive elastomer materials, the dielectric layer 4 and the conductive layer 5 can be bonded to the printed circuit board through a known process such as vacuum thermoforming, without the need to use a wire or a pin, which is very convenient for manufacturing.

The shielding solution of the disclosure to shield the electronic devices 2 by arranging the dielectric layer 4 and the conductive layer 5 is particularly applicable to a rigid printed circuit board, or a rigid portion of a rigid-flex printed circuit board.

It should be appreciated that the above embodiments are merely some exemplary embodiments for demonstrating the principles of the invention, and the invention is not limited thereto. A person of ordinary skill in the art can make various variations and improvements without departing from the spirit and essence of the invention which shall fall within the scope of the present invention.

What is claimed is:

1. A printed circuit board assembly (PCBA), comprising a printed circuit board and a plurality of electronic devices disposed on the printed circuit board, wherein the PCBA further comprises a dielectric layer and a conductive layer that cover the plurality of electronic devices to shield the plurality of electronic devices, and wherein the dielectric layer is arranged between the plurality of electronic devices and the conductive layer.

2. The PCBA of claim 1, wherein the printed circuit board is a multilayer board comprising a ground layer that surrounds the plurality of electronic devices to define a shielding area, and wherein the conductive layer is connected to the ground layer.

3. The PCBA of claim 1, wherein the printed circuit board is a rigid board or a rigid portion of a rigid-flex board.

4. The PCBA of claim 1, wherein the plurality of electronic devices includes at least one of a capacitor, a resistor, an inductor, a chip, and a filter.

5. The PCBA of claim 1, wherein the electronic devices have different protrusion heights on the printed circuit board.

6. The PCBA of claim 1, wherein the dielectric layer is a film made of a non-conductive elastomer material.

7. The PCBA of claim 1, wherein the conductive layer is a film made of a conductive elastomer material.

8. The PCBA of claim 1, wherein the dielectric layer and the conductive layer are bonded to the printed circuit board by vacuum thermoforming, spray coating or film adhesion.

9. A radio unit comprising the PCBA of claim 1.

10. A base station comprising the radio unit of claim 9.
